(19) United States
(12) Patent Application Publication
(10) Pub. No.: US 2026/0267592 A1
(43) Pub. Date: Sep. 10, 2026

(54) INTEGRATED IN-VEHICLE PERSONAL AUDIO SYSTEM

(71) Applicant: HARMAN INTERNATIONAL INDUSTRIES, INCORPORATED, Stamford, CT (US)

(72) Inventors: Christopher LUDWIG, Bloomfield Hills, MI (US); Gorm Haldor JØRGENSEN, Struer (DK); Riley WINTON, Opelika, AL (US); David Patrick SCHNEIDER, Bloomfield Hills, MI (US)

(21) Appl. No.: 19/166,227

(22) PCT Filed: Apr. 12, 2023
(86) PCT No.: PCT/US2023/018290

§ 371 Date: Sep. 17, 2025

(51) Int. Cl. G06F 3/16; H04M 1/60; H04M 1/72409; H04M 1/72412; H04R 1/32

(52) U.S. Cl. CPC G06F 3/165; G06F 3/162; H04M 1/724098; H04M 1/72412; H04R 1/323; H04M 1/6091; H04R 2420/07; H04R 2499/13

(57) ABSTRACT

Various embodiments disclose a computer-implemented method comprising detecting, by a wireless audio unit of a vehicle, one or more personal audio devices within the vehicle, establishing a wireless link with at least a first personal audio device of the one or more personal audio devices, synchronizing communications over the wireless link to the first personal audio device, and transmitting, from the wireless audio unit to the first personal audio device, an audio signal over the wireless link for playback by the first personal audio device.

### BACKGROUND

### Field of the Various Embodiments

The various embodiments relate generally to audio systems and, more specifically to integrated in-vehicle personal audio systems.

### Description of the Related Art

Vehicles typically include vehicle entertainment systems, such as in-car entertainment (ICE) or in-vehicle infotainment (IVI) systems, which include various hardware and software components that enhance the driver and passenger experience by providing audio or video entertainment, video gaming capability, Internet connectivity, and associated features to passengers and drivers. A given vehicle can include multiple devices, such as mounted units, rear-seat entertainment (RSE) units mounted on a vehicle seat, and/or portable devices that connect to the vehicle. Typically, each device is connected to a central hub, such as a head unit mounted near the driver seat and/or within the dashboard of the vehicle.

One drawback of conventional vehicle entertainment systems is that the vehicle entertainment system has difficulty providing high-fidelity audio reproductions for occupants of the vehicle. For example, in contrast to personal audio systems (e.g., headphones, directional loudspeakers, etc.), conventional vehicle entertainment systems include loudspeaker configurations that have difficulty reproducing high-fidelity reproductions of audio signals. Conventional audio systems capable of reproducing high-fidelity reproductions highly complex and occupy a large amount of space in the vehicle. Further, the complexity of such systems require expensive components and additional costs for maintenance. Some solutions have been proposed that include wearing conventional personal audio systems within the vehicle. However, such personal audio systems are considered unsafe, as such systems block large amounts of information regarding the driving environment and are considered unsafe for occupants of the vehicle. Another drawback of conventional vehicle entertainment systems is that generating personalized audio fields for occupants requires a great amount of control and networking resources. For example, when multiple users are participants in a group telephone call, the vehicle entertainment system must separately transmit the media feed of each participant. However, providing separate feeds in this manner requires large amounts of processing and networking resources. Further, various techniques to enable group voice chat, such as muting the microphones of other participants, may make the conversation stilted within the vehicle, as the proximity of the occupants in the vehicle causes such audio blocking techniques to feel unnatural.

In light of the above, more effective techniques for providing personalized audio within the vehicle would be useful.

### SUMMARY

Various embodiments disclose a computer-implemented method comprising detecting, by a wireless audio unit of a vehicle, one or more personal audio devices within the vehicle, establishing a wireless link with at least a first personal audio device of the one or more personal audio devices, synchronizing communications over the wireless link to the first personal audio device, and transmitting, from the wireless audio unit to the first personal audio device, an audio signal over the wireless link for playback by the first personal audio device.

Further embodiments provide, among other things, non-transitory computer-readable storage media storing instructions for implementing the method set forth above, as well as a system configured to implement the method set forth above.

At least one technological advantage of the integrated in-vehicle personal audio system relative to the prior art is that, with the disclosed techniques, the integrated in-vehicle personal audio system provides high-fidelity audio reproductions of audio signals within a vehicle while providing contextual information about a driving environment to occupants of the vehicle. Further, by incorporating compatible personal audio components to generate a personalized sound zone for a given occupant, the integrated in-vehicle personal audio system provides a less-complex, more cost-efficient solution to provide high-fidelity audio to individuals than conventional in-vehicle audio systems. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of the wireless audio system configured to implement one or more aspects of the present disclosure;

FIG. 2 illustrates an example vehicle system that includes the wireless audio unit 116 of FIG. 1, according to various embodiments;

FIG. 3 illustrates an example configuration that includes the wireless audio unit of FIG. 1, according to various embodiments;

FIG. 4 illustrates an interior of an example vehicle including the wireless audio unit of FIG. 1, according to various embodiments;

FIG. 5 illustrates a flow diagram of method steps for synchronizing an audio stream between a wireless audio unit and a personal audio device of FIG. 1, according to various embodiments; and

FIG. 6 illustrates a flow diagram of method steps for generating a mixed audio signal based on data from a vehicle environment, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### Overview

Embodiments disclosed herein include a wireless audio system that includes a wireless audio unit that establishes communications with one or more personal audio devices within a vehicle. The wireless audio unit synchronizes communications with the personal audio devices to control audio playback of content in conjunction with, or in lieu of, audio playback via speakers within the vehicle. During playback, the wireless audio unit adds audio components based on data associated with the environment, such as adding audio clips of the outside environment acquired by outside microphones or adding audio tone notifications associated with specific alerts. The wireless audio unit mixes the additional audio components with the audio signal from an audio source to generate a mixed audio signal that ducks the audio signal from the audio source while providing the addition audio components. In this manner, a listener within the vehicle can receive high-fidelity audio content from the personal audio device while receiving auditory information about the environment in the vehicle and surrounding the vehicle.

### System Overview

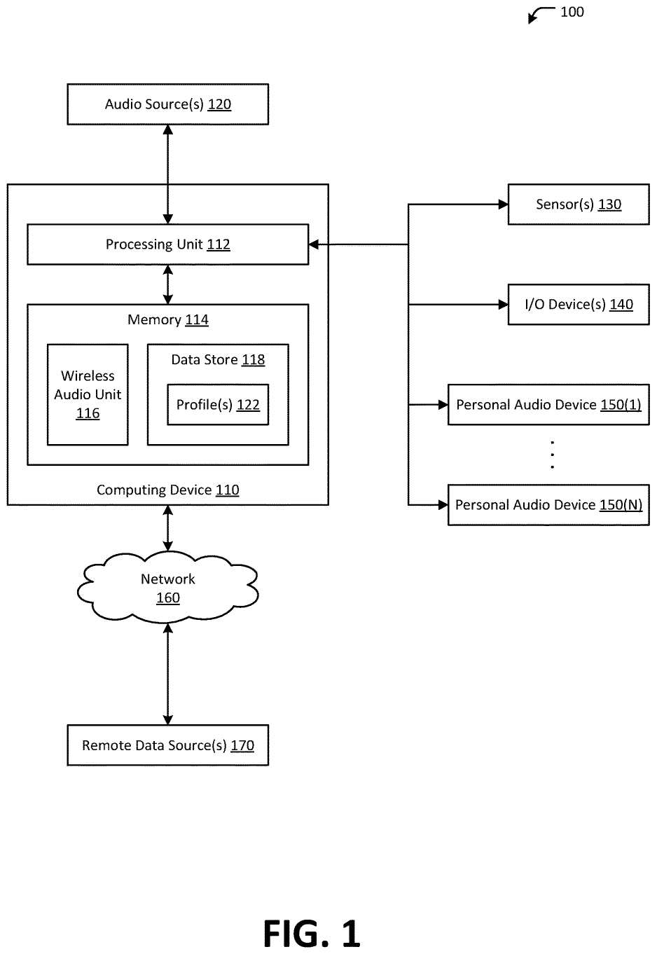

FIG. 1 illustrates a block diagram of the wireless audio system 100 configured to implement one or more aspects of the present disclosure. As shown, and without limitation, the wireless audio system 100 includes a computing device 110, audio source(s) 120, sensor(s) 130, input/output (I/O) devices 140, personal audio devices 150 (e.g., 150(1) to 150(N)), a network 160, and remote data source(s) 170. The computing device 110 includes, without limitation, a processing unit 112 and memory 114. The memory 114 includes, without limitation, a wireless audio unit 116 and a data store 118. The data store 118 includes, without limitation, profile(s) 122.

For explanatory purposes, multiple instances of like objects are denoted with reference numbers identifying the object and additional numbers identifying the instance where needed (e.g., the personal audio device 150(1)). Further, the wireless audio system 100 includes multiple instances of devices, even when not shown.

In operation, the computing device 110 executes the wireless audio unit 116 to control the audio playback of audio from one or more vehicle components and/or personal audio devices 150 within the vehicle. In particular, the processing unit 112 receives data from the sensors 130, the I/O devices 140, and/or the personal audio devices 150. The wireless audio unit 116 processes the data to detect the presence of at least one personal audio device 150 (e.g., the personal audio device 150(1)). Upon detecting the personal audio device 150(1), the wireless audio unit 116 determines whether the personal audio device 150(1) is known and, if so, whether the personal audio device 150(1) is associated with a known user and/or user profile. When the device or user is known, the wireless audio unit 116 loads a profile 122 for the user and/or the personal audio device 150(1). The profile 122 includes configuration information associated with audio reproduction using the personal audio device 150(1) and/or vehicle speakers, including one or more of specific equalizer settings, selected speaker preferences, auditory augmented reality (AR) preferences, and so forth. The wireless audio unit 116 uses the profile to determine which audio output devices (e.g., the personal audio device 150(1), one or more vehicle speakers, etc.) to use to reproduce audio signals and how to modify an incoming audio signal. The wireless audio unit 116 establishes a wireless communication link with the personal audio device 150(1). In various embodiments, the wireless audio unit 116 determines the position of the personal audio device 150(1), determines a sound zone for the determined position and manages speakers within the sound zone. In some embodiments, the wireless audio unit 116 mutes the speakers in the sound zone such that only the personal audio device 150(1) reproduces an audio signal within the sound zone. Alternatively, in some embodiments, the wireless audio unit 116 controls the set of speakers in the sound zone in conjunction with the personal audio device 150(1) such that the personal audio device 150(1) and set of speakers collectively reproduce an audio signal.

When the wireless audio unit 116 streams an audio signal to the sound zone for reproduction, the wireless audio unit 116 continually processes incoming data from various devices (e.g., the sensors 130, the remote data sources 170, other vehicle components, etc.) to determine whether to mix additional audio components with the audio signal. The additional audio components can include an audio clip recorded by a microphone, such as sounds from outside the vehicle or an utterance of another vehicle occupant. Additionally or alternatively, the additional audio components can include an audio tone associated with an event type triggered by the incoming data (e.g., an audio notification indicating a navigational tone, an alert notification based on a controller area network message, etc.). When the wireless audio unit 116 determines to add an additional audio component, the wireless audio unit mixes the audio signal with the additional audio component, ducking the audio signal as needed to produce an attenuated version of the audio signal that enables the additional audio component to be heard by the user. The wireless audio unit 116 transmits the mixed audio signal to the speakers in the sound zone for reproduction.

The computing device 110 includes the processing unit 112 and the memory 114. In various embodiments, the computing device 110 is a device that includes one or more processing units 112, such as a system-on-a-chip (SoC). In various embodiments, the computing device 110 is a mobile computing device, such as a tablet computer, mobile phone, media player, and so forth that wirelessly connects to other devices in the vehicle. In some embodiments, the computing device 110 is a head unit included in a vehicle system. Additionally or alternatively, the computing device 110 can be a detachable device that is mounted in a portion of a vehicle as part of an individual console. Generally, the computing device 110 is configured to coordinate the overall operation of the wireless audio system 100. The embodiments disclosed herein contemplate any technically feasible system configured to implement the functionality of the wireless audio system 100 via the computing device 110. The functionality and techniques of the wireless audio system 100 are also applicable to other types of vehicles, including consumer vehicles, commercial trucks, airplanes, helicopters, spaceships, boats, submarines, and so forth.

The processing unit 112 can include one or more central processing units (CPUs), digital signal processing units (DSPs), microprocessors, application-specific integrated circuits (ASICs), neural processing units (NPUs), graphics processing units (GPUs), field-programmable gate arrays (FPGAs), and so forth. The processing unit 112 generally includes a programmable processor that executes program instructions to manipulate input data and generate outputs. In some embodiments, the processing unit 112 can include any number of processing cores, memories, and other modules for facilitating program execution. For example, the processing unit 112 could receive input from a user via the I/O devices 140 and generate pixels for display on an I/O device 140 (e.g., a display device). In some embodiments, the processing unit 112 is configured to execute the wireless audio unit 116 to control audio playback on one or more devices, including one or more personal audio devices 150. In such instances, the wireless audio unit 116 mixes additional audio signals based on data from multiple devices to provide a mixed audio signal that incorporates information from the vehicle environment.

The memory 114 can include a memory module or collection of memory modules. The memory 114 generally comprises storage chips such as random-access memory (RAM) chips that store application programs and data for processing by the processing unit 112. In various embodiments, the memory 114 includes non-volatile memory, such as optical drives, magnetic drives, flash drives, or other storage. In some embodiments, separate data stores, such as the remote data sources 170 connected to the network 160 (e.g., “cloud storage”) are connected to the wireless audio unit 116. The wireless audio unit 116 within the memory 114 is executed by the processing unit 112 to implement the overall functionality of the computing device 110 and, thus, coordinate the operation of the wireless audio system 100 as a whole.

The wireless audio unit 116 processes incoming data from one or more devices and controls the personal audio devices 150 and/or other vehicle speakers to reproduce audio signals. In various embodiments, the wireless audio unit 116 establishes communications channels in configurations to provide high fidelity audio content in the audio signal that the personal audio device 150 reproduces. In various embodiments, the wireless audio unit 116 scales connections to the personal audio devices 150(1)-150(N). For example, the wireless audio unit 116 can connect to six separate personal audio devices simultaneously inside a vehicle. In some embodiments, the wireless audio unit 116 detects the personal audio device 150 as the device enters or gets close to the vehicle. For example, the wireless audio unit 116 can use ultrawideband (UWB) communications and/or near-field communications (NFC) to detect that the personal audio device 150 is proximate to, or within, the vehicle. In various embodiments, the wireless audio unit 116 gathers various types of data and provide notifications about the data to the user. For example, the wireless audio unit 116 can provide super hearing functionality to a given personal audio device 150 by acquiring sounds (e.g., ambient sounds, voices of other occupants, etc.) from external and/or internal microphones and mixing the acquired sounds with the audio signal such that the user hears the acquired sounds while using the personal audio device 150.

The data store 118 is a portion of the memory 114 that stores various data locally, including profiles 122 (e.g., user profiles, device profiles, etc.) and other data (not shown), such as content items, data tables (e.g., a table mapping audio tones to events) and/or application data (e.g., secure application data, metadata, etc.) associated with the wireless audio unit 116. In various embodiments, the data store 118 can be included in volatile memory and can correspond to a section of nonvolatile memory. In some embodiments, the computing device 110 can sync data between the volatile memory and the nonvolatile memory so that copies of data are stored in both the volatile and nonvolatile memory. In some embodiments, the data store 118 store downloaded content items received via network 160 in order to enable playback when access to the network 160 is unavailable or when the network resources of the vehicle are limited.

The profile(s) 122 include device profiles associated with specific personal audio devices 150 and/or user profiles associated with specific users. In some embodiments, the user profile is linked to one or more device profiles and vice versa. In such instances, the wireless audio unit 116 prompts the user to select which personal audio device 150 is in use. In various embodiments, the profile 122 includes configuration information associated with audio reproduction of an audio signal using the personal audio device 150 and/or vehicle speakers. Such configuration can, include, for example, specific equalizer settings, selected speaker preferences, auditory augmented reality (AR) preferences, and so forth. The wireless audio unit 116 uses the profile to determine which audio output devices (e.g., the personal audio device 150(1), one or more vehicle speakers, etc.) to use to reproduce audio signals and how to modify an incoming audio signal.

The audio source(s) 120 include one or more data sources that provide the audio signal for reproduction. In various embodiments, the audio source 120 is included in a device within the vehicle, such as an entertainment subsystem included in the head unit of the vehicle, a rear-seat entertainment console, a device mounted in the vehicle, and so forth. In some embodiments, the audio source 120 is included in a mobile device, wearable device, and/or other portable device that connects to the wireless audio unit 116. Additionally or alternatively, the audio source 120 can be remote to the vehicle. For example, the audio source 120 can be included in the remote data source 170. In such instances, the remote data source streams the audio signal to the computing device 110, whereupon the wireless audio unit 116 transmits the audio signal to the personal audio device 150 for reproduction.

The sensors 130 includes one or more devices that perform measurements and/or acquire data related to certain subjects in an environment. In various embodiments, the sensors 130 generates sensor data that is related to the user and/or objects in the environment that are not the user. In some embodiments, the sensors 130 is coupled to and/or included within the computing device 110 and sends sensor data to the processing unit 112.

In various embodiments, the sensors 130 include audio sensors, such as microphones and/or a microphone array that record external sounds and/or internal microphones that record sounds within the compartment of the vehicle. In some embodiments, the sound data acquired by the microphones is processed by the wireless audio unit 116 performing various natural language (NL) processing techniques, sentiment analysis, and/or speech analysis in order to determine the semantic meaning of the phrases spoken in the environment.

In some embodiments, the sensors 130 includes optical sensors, such as RGB cameras, infrared cameras, depth cameras, and/or camera arrays, which include two or more of such cameras. Other optical sensors can include imagers and laser sensors. In some embodiments, the sensors 130 includes physical sensors, such as touch sensors, pressure sensors, position sensors (e.g., an accelerometer and/or an inertial measurement unit (IMU)), motion sensors, and so forth, that register the body position and/or movement of the user and/or the personal audio device 150. In some embodiments, the sensors 130 includes physiology sensors, such as heart-rate monitors, electroencephalography (EEG) systems, radio sensors, thermal sensors, galvanic skin response sensors (e.g., sensors that measure change in electrical resistance of skin caused by emotional stress), contactless sensor systems, magnetoencephalography (MEG) systems, and so forth.

The input/output (I/O) devices 140 includes devices capable of receiving input, such as a keyboard, a mouse, a touch-sensitive screen, a microphone, and other input devices for providing input data to the computing device 110. In various embodiments, the I/O devices 140 is associated with a specific console, such as personalized screens mounted to a portion of a seat, the personal audio device 150, personalized loudspeakers within the vehicle, console-specific input components, and so forth. Additionally or alternatively, the I/O devices 140 include various devices capable of providing output, such as a display screen, loudspeakers, and the like. In various embodiments, one or more of the I/O devices 140 is incorporated in the computing device 110, or is external to the computing device 110. In some embodiments, the computing device 110 and/or the one or more I/O devices 140 can be components of an advanced driver assistance system (ADAS) or an entertainment subsystem included in the vehicle. In various embodiments, the wireless audio unit 116 responds to various inputs received by the one or more I/O devices 140. For example, the vehicle could include a head unit that includes a user interface. In such instances, the wireless audio unit 116 could respond to one or more touch inputs and/or NL voice inputs received via the head unit.

The personal audio devices 150 (e.g., 150(1) to 150(N)) include one or more headphones, earbuds, wearable devices, and/or other types of personalized audio devices that reproduce audio signals to provide audio content to an individual. In some embodiments, the personal audio device 150 provides directional sound (e.g., a collar that provides directional loudspeakers) in a manner that provides personalized audio to the listener. In some embodiments, the personal audio devices 150 are configured to provide equalization, noise cancellation, audio augmented reality, high fidelity audio, and/or other features. In some embodiments, the personal audio devices 150 uses a specialized protocol and/or are fabricated using a specialized hardware to communicate with the wireless audio unit 116 with low latency.

The network 160 enables communications between the computing device 110 and other devices in network 160 via wired and/or wireless communications protocols, satellite networks, V2X networks, including Bluetooth, Bluetooth low energy (BLE), wireless local area network (WiFi), cellular protocols, and/or near-field communications (NFC).

The remote data source(s) 170 includes a computing device, such as a laptop, tablet, smart phone, cellular phone, desktop, teleconferencing system, etc., that communicates with the computing device 110. In some embodiments, the remote data source is a software service or a device that executes a media application, such as audio software, video software, audio call software, messaging software, media serving platforms, and so forth. In such instances, the remote data source 170 can use such media applications to communicate with the wireless audio unit 116 operating within the vehicle.

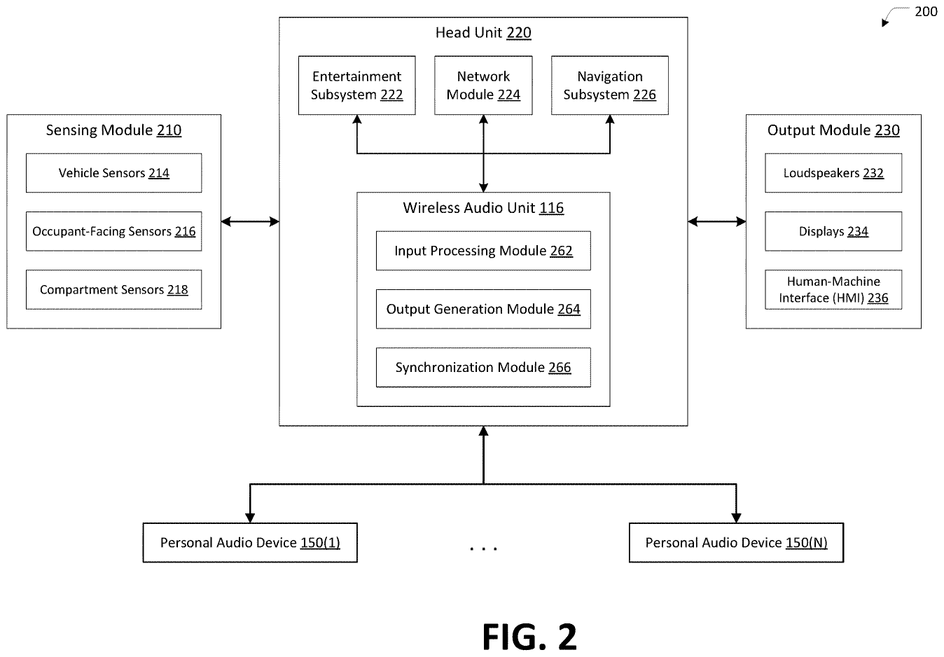

FIG. 2 illustrates an example vehicle system 200 that includes the wireless audio unit 116 of FIG. 1, according to various embodiments. As shown, the vehicle system 200 includes, without limitation, a sensing module 210, a head unit 220, an output module 230, and a set of personal audio devices 150 (e.g., 150(1) to 150(N)). The sensing module 210 includes, without limitation, vehicle sensors 214, occupant-facing sensors 216, and compartment sensors 218. The head unit 220 includes, without limitation, the wireless audio unit 116, an entertainment subsystem 222, a network module 224, and a navigation subsystem 226. The output module 230 includes, without limitation, loudspeakers 232, displays 234, and a human-machine interface (HMI) 236. The wireless audio unit 116 includes, without limitation, an input processing module 262, an output generation module 264, and a synchronization module 266.

In operation, the wireless audio unit 116 establishes connections with the set of personal audio devices 150. The wireless audio unit 116 transmits audio signals to the personal audio devices 150 and processes incoming data from the sensing module 210 and/or components of the head unit 220 to determine whether to add additional audio components to a given audio signal. The wireless audio unit 116 then adds audio clips and/or audio tones to the audio signal to provide the user with information about the vehicle environment.

The sensing module 210 includes multiple types of sensors, including vehicle sensors 214 (e.g., outward-facing cameras, external microphones, accelerometers, etc.), occupant-facing sensors 216 (e.g., cameras, microphones, motion sensors, etc.), and/or compartment non-occupant facing sensors 218 (e.g., pressure sensors, temperature sensors, etc.). In various embodiments, the sensing module 210 provides a combination of sensor data that describes the context of the vehicle and the occupants that are present within the vehicle. For example, the sensing module 210 can provide a set of values associated with the occupants (e.g., positions of occupants, positions of the personal audio devices 150, noise level, etc.). In such instances, the wireless audio unit 116 can identify which seats within the vehicle are occupied..

In various embodiments, the vehicle sensors 214 further includes other external sensors. Such external sensors can include optical sensors, road vibration sensors, temperature sensors, etc. In some embodiments, the sensing module 210 and/or the network module 224 acquires other external data, such as geolocation data (e.g., GNSS systems, including a global positioning system (GPS), Glonass, Galileo, etc.), demographic data, psychographic data, and so forth. In such instances, the wireless audio unit 116 can process the incoming data. For example, the wireless audio unit 116 can add notification tones about points of interest to the user based on the geolocation of the vehicle. In another example, the wireless audio unit 116 provides alerts from the driver assistance system upon detection of an alert condition and provides audio clips of ambient sounds associated with the alert condition. In some embodiments, navigation data and/or geolocation data is combined and associated with a particular media configuration. For example, upon the navigation subsystem 226 generating a route between locations the wireless audio unit 116 provides audio tones associated with navigating the route (e.g., adding voice generated clips of the navigation instructions).

The head unit 220 is a component of the vehicle that is mounted at any location within a passenger compartment of the vehicle in any technically feasible fashion. In some embodiments, the head unit 220 includes any number and type of instrumentation and applications and provides any number of input and output mechanisms. For example, the head unit 220 enables users (e.g., the driver and/or passengers) to control the entertainment subsystem 222 and/or the navigation subsystem 226. The head unit 220 supports any number of input and output data types and formats, as known in the art. For example, the head unit 220 could include built-in Bluetooth for hands-free calling and/or audio streaming, universal serial bus (USB) connections, speech recognition, rear-view camera inputs via the sensing module 210, video outputs via the output module 230 for any number and type of displays 234, and any number of audio outputs. In general, any number of sensors (e.g., sensors 130, 214, 216, 218), displays 234, receivers, transmitters, etc., can be integrated into the head unit 220, or can be implemented externally to the head unit 220. Additionally or alternatively, the wireless audio unit 116 can be integrated into the head unit 220, or can be implemented externally to the head unit 220. In various embodiments, external devices (e.g., the personal audio devices 150) communicates with the head unit 220 in any technically feasible fashion.

The entertainment subsystem 222 provides various information to the user and/or one or more other occupants of the vehicle via the output module 230. The navigation subsystem 226 provides information about the location of the vehicle and pathfinding information to reach a route. For example the navigation subsystem via the head unit 220 and/or the HMI 236 could provide route information associated with the vehicle. The entertainment subsystem 222 enables playback of audio and/or video content from various media sources (e.g., internal sources or external media providers via the network module 224). In various embodiments, the entertainment subsystem enables playback of content via the wireless audio unit 116 and/or other output devices (e.g., the output devices 140, loudspeakers 232, displays 234, and/or HMI 236) included in the output module 230.

The output module 230 performs one or more actions in response to actions performed by the head unit 220 and/or the wireless audio unit 116. For example, the output module 230 can generate one or more output signals in response to received media signals to drive the output of the loudspeakers 232 and/or the display 234. In another example, the output module 230 could generate one or more output signals to modify the human-machine interface (HMI) 236 to display notification messages and/or alerts. In some embodiments, the HMI 236 is a different component than the display 234, such as when the HMI 236 is included as part of the windshield. In such instances, the head unit 220 can specify whether a notification is to be displayed via the display 234 or via the HMI 236.

The wireless audio unit 116 includes various modules to manage the processing of data and to manage the transmission of audio signals for reproduction. In various embodiments, the wireless audio unit 116 implements one or more of the input processing module 262, the output generation module 264, and/or the synchronization module 266 simultaneously to establish wireless communication links with one or more of the personal audio devices 150 and mix additional audio components into an audio signal provided by the audio source 120.

The input processing module 262 processes various types of data from one or more components and/or devices. For example, the input processing module 262 processes incoming data from one or more devices to detect that a given personal audio device 150 is at a position within the vehicle. For example, the input processing module 262 can process sensor data from the sensors 130 (e.g., compartment sensors 218) indicating the position of the personal audio device 150 within the vehicle 302. In some embodiments, the wireless audio unit 116 receives messages directly from the personal audio device 150(N). Additionally or alternatively, the input processing module 262 processes incoming data from various devices associated with the environment, such as audio data from microphones recording the exterior environment of the vehicle, utterances from other occupants of the vehicle, events associated with the operation of the entertainment subsystem 222, the network module 224, the navigation subsystem 226, and so forth.

The output generation module 264 provides the audio signal to the personal audio devices 150 and/or the loudspeakers 232 for reproduction. In various embodiments, the output generation module 264 responds to a determination to mix additional audio content with the audio signal by generating the additional audio content and generating a mixed audio signal that includes the audio signal provided by the audio source 120 and the additional audio content. In some embodiments, the output generation module 264 extract audio content from incoming data. For example, the output generation module 264 generates an audio clip by extracting a portion of ambient sound data from the microphones included in the vehicle sensors 214. In another example, the output generation module 264 adds a notification sound indicating a change in audio track based on a notification message generated by the entertainment subsystem 222. In various embodiments, the output generation module 264 applies various equalization, noise reduction, and/or other sound modification techniques based on one or more profiles 122. For example, the output generation module 264 retrieves a device profile 122 associated with the personal audio device 150 and uses the device profile as an output profile to modify the audio signal before transmitting the modified audio signal to the personal audio device 150 for reproduction.

The synchronization module 266 establishes communications with the personal audio devices 150 and performs various techniques to establish wireless communication links to the personal audio devices 150 and reduce latency when transmitting the audio signal to the personal audio devices 150. For example, the synchronization module 266 exchanges messages with the personal audio device 150 to determine the position of the personal audio device 150 within the vehicle and exchanges a set of messages to determine the characteristics for the wireless communication link that is to be established (e.g., negotiating a capability set for the wireless communication link 312(N), determining whether to establish a back channel, determining content protection, payload composition, etc.). Upon determining the characteristics, the wireless audio unit 116 establishes the wireless communications link with the personal audio device 150. Additionally or alternatively, the synchronization module 266 performs various techniques to reduce the latency between the audio source providing the audio signal and the personal audio device 150. For example, the wireless audio unit can dedicate a larger amount of processing resources to increase the throughput over the wireless communications links.

In various embodiments, the synchronization module 266 establishes communications with a given personal audio device 150 upon determining that the personal audio device 150 is a certified component that is confirmed to interoperate with the wireless audio unit 116. In such instances, the synchronization module 266 establishes connectivity to the loudspeakers 232 in lieu of the personal audio device 150 upon determining that the personal audio device 150 is not certified to operate with the wireless audio unit 116. Additionally or alternatively, the synchronization module 266 establishes connectivity to the loudspeakers 232 when the personal audio device 150 is not present or is not powered.

### Wireless Audio Synchronization and Management

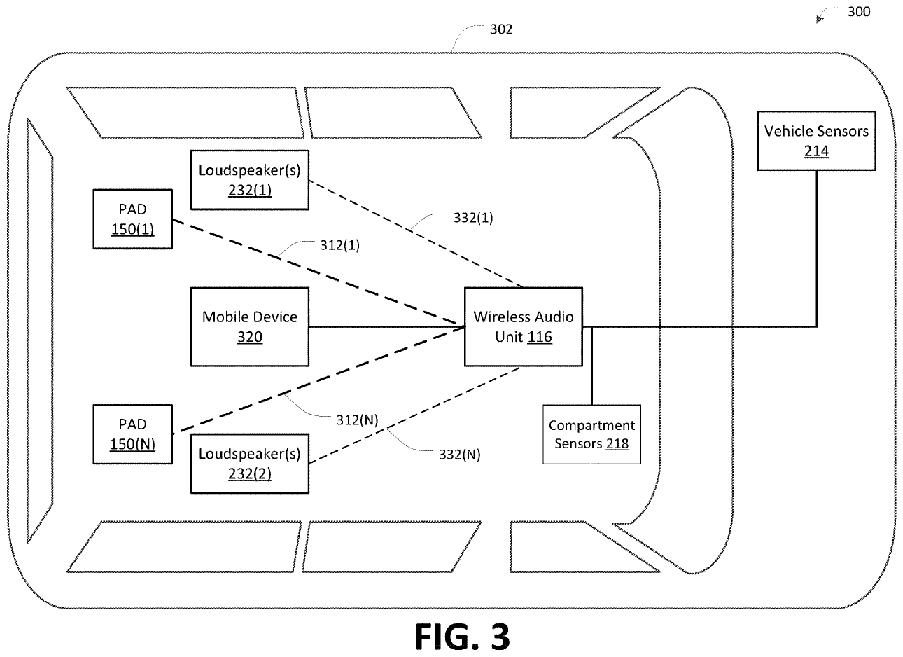

FIG. 3 illustrates an example system 300 that includes the wireless audio unit 116 of FIG. 1, according to various embodiments. As shown, the system 300 includes, without limitation, a vehicle 302, a mobile device 320, personal audio devices 150, wireless communications links 312, and audio links 332.

In operation, the mobile device 320 connects to the wireless audio unit 116 to provide an audio signal. The wireless audio unit 116 concurrently establishes streaming sessions with each of the personal audio devices 150(1), 150(2) and controls the loudspeakers 232(1), 232 respectively proximate to the position of the personal audio devices 150(1),150 and provides the audio signal via the audio links 332. The wireless audio unit 116 receives data from the vehicle sensors 214 and/or the compartment sensors 218 and generates mixed audio signals that incorporate information provided by the sensors 214, 218. The wireless audio unit 116 transmits the audio signal and/or the mixed audio signal to the personal audio devices 150 via the wireless communication links 312 and/or the loudspeakers 232 via the audio links 332.

In various embodiments, the personal audio device 150 uses a communications protocol, such as Bluetooth, to establish the wireless communication link 312. In various embodiments, the wireless audio unit specifies the characteristics of the wireless communications links 312 and/or the audio links 332 for the respective personal audio devices 150. For example, the wireless audio unit 116 can mute the loudspeakers 232(1). In such instances, the wireless audio unit refrains from providing an audio signal to the loudspeakers 232(1). Alternatively, in some embodiments, the wireless audio unit 116 can transmit inaudible audio signals (e.g., noise cancellation signals) for reproduction by the loudspeakers 232(1). In another example, the wireless audio unit 116 can generate a set of component audio signals based on the audio signal and can separately transmit the component audio signals to the personal audio device 150(N) and loudspeakers 232(N), respectively. In such instances, the personal audio device 150(N) and loudspeakers 232(N) reproduce the respective component signals to collectively reproduce the audio signal provided by the audio source 120.

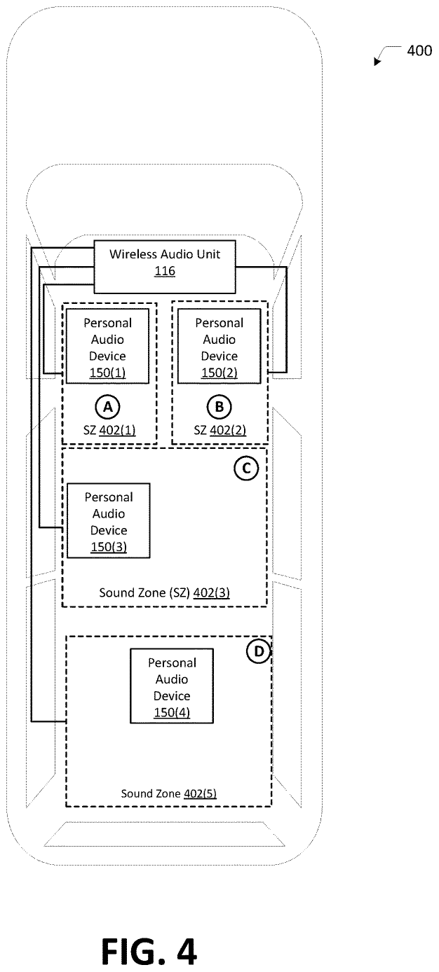

FIG. 4 illustrates an interior 400 of an example vehicle 302 including the wireless audio unit 116 of FIG. 1, according to various embodiments. As shown, the interior 400 includes, without limitation, personal audio devices 150 and sound zones 402 (e.g., 402(1), 402(2), etc.).

In various embodiments, the vehicle 302 includes various sets of loudspeakers 232 that generate a plurality of sound zones (e.g., 402(1), 402(2)) that are located at distinct positions within the vehicle 302 and provide personalized audio to an occupant. In some embodiments, the vehicle 302 includes multiple sets of loudspeakers 232 that generate sound zones 402(1)-402(6) in areas of the vehicle that correspond to individual seats or larger areas (e.g., the back row). In such instances, each sound zone 402 is located in an area proximate to a seat such that the ears of the occupant are within the sound zone 402 when seated at a specific position. For example, as shown, when an occupant sits in the front row passenger seat, the ears of the occupant are located within the sound zone 402(2).

In various embodiments, the one or more output devices 140 associated with the corresponding console and/or other loudspeakers 232 positioned proximate to the seat generate the sound zone 402. In such instances, the wireless audio unit 116 con control the loudspeakers 232 for a given sound zone 402 such that the personal audio device 150 operates in conjunction with, or in lieu of, the loudspeakers 232 in the sound zone 402. In such instances, the occupant of the sound zone hears the reproduced audio signal while other occupants hear little or none of the reproduced audio signal.

In some embodiments, the wireless audio unit 116 determines the sound zone based on the position of each personal audio device 150. For example, the wireless audio unit 116 determines that the personal audio device 150(4) is being worn by the occupant in the back row. In such instances, the wireless audio unit 116 modifies the sound zone 402(5) to include the entire back row. The wireless audio unit 116 then controls the set of loudspeakers 232 for the back row based on the configuration associated with the personal audio device 150(4) (e.g., selection of only subwoofers) and/or the preferences of the user (e.g., a stored user profile with a preference to mute all loudspeakers 232 in the sound zone 402(5).

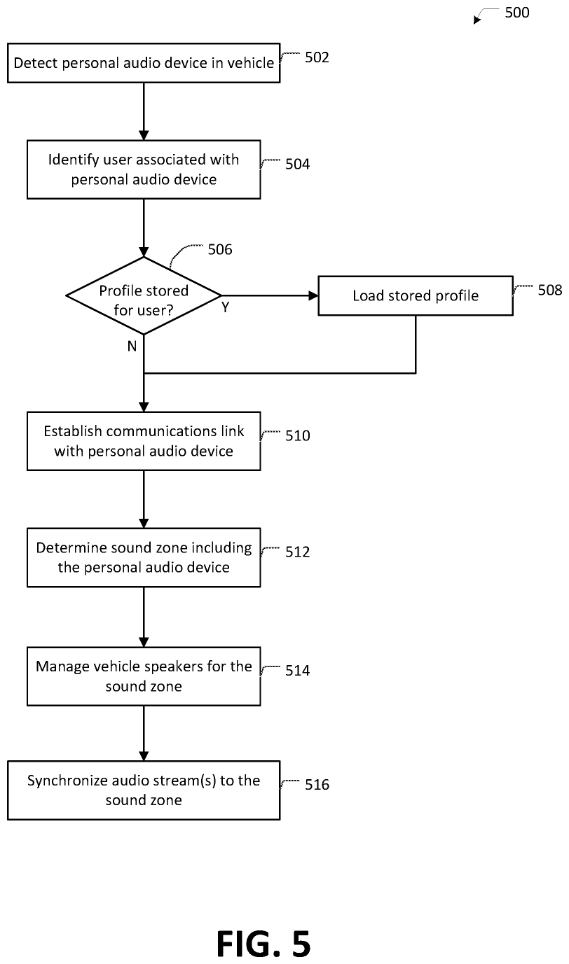

FIG. 5 illustrates a flow diagram of method steps for synchronizing an audio stream between a wireless audio unit 116 and a personal audio device 150 of FIG. 1, according to various embodiments. Although the method steps are described with respect to the systems of FIGS. 1-4, persons skilled in the art will understand that any system configured to perform the method steps, in any order, falls within the scope of the various embodiments.

As shown, the method 500 begins at step 502, where the wireless audio unit 116 detects a personal audio device 150 in a vehicle 302. In various embodiments, the wireless audio unit 116 processes incoming data from one or more devices to detect that a given personal audio device 150(N) is at a position within the vehicle 302. In some embodiments, the input processing module 262 included in the wireless audio unit 116 processes sensor data from the sensors 130 (e.g., compartment sensors 218) indicating the position of the personal audio device 150(N) within the vehicle 302. In some embodiments, the wireless audio unit 116 receives messages directly from the personal audio device 150(N). In such instances, the synchronization module 266 of the wireless audio unit 116 exchanges messages with the personal audio device 150(N) to determine the position of the personal audio device 150(N) within the vehicle 302.

At step 504, the wireless audio unit 116 identifies a user associated with the personal audio device 150(N). In various embodiments, the wireless audio unit 116 identifies a device identifier associated with the personal audio device 150(N). In such instances, the wireless audio unit 116 scans the profiles 122 in the data store 118 to determine whether the personal audio device 150(N) is associated with a specific user and/or user profile. Alternatively, in some embodiments, the user provides an input via an input device (e.g., the mobile device 320, a vehicle console, etc.) to provide a check-in. In such instances, the wireless audio unit 116 uses the information provided by the user during check-in to locate a profile 122 associated with the user.

At step 506, the wireless audio unit 116 determines whether any profile 122 stored in the data store 118 is associated with the user. When the wireless audio unit 116 identifies a profile 122 for the user, the wireless audio unit 116 proceeds to step 508, where the wireless audio unit 116 loads the profile 122 from the data store 118. Otherwise, when the wireless audio unit 116 does not identify a profile 122 for the user and proceeds to step 510. In some embodiments, the wireless audio unit 116 generates a profile for the user for use to stream to the personal audio device 150(N).

At step 510, the wireless audio unit 116 establishes a communication link 312 with the personal audio device 150(N). In various embodiments, the wireless audio unit 116 generates a direct connection with the personal audio device 150(N) by establishing a wireless communication link 312(N) with the personal audio device 150(N). In various embodiments, the synchronization module 266 included in the wireless audio unit 116 and the personal audio device 150(N) exchanges a set of messages to determine the characteristics of the wireless communication link 312(N) (e.g., negotiating a capability set for the wireless communication link 312(N), determining whether to establish a back channel, determining content protection, payload composition, etc.). Upon determining the characteristics, the wireless audio unit 116 establishes the wireless communications link 312(N) with the personal audio device 150(N).

At step 512, the wireless audio unit 116 determines a sound zone that includes the personal audio device 150(N). In various embodiments, the input processing module 262 of the wireless audio device processes a set of input data to determine the position of the personal audio device 150(N) and identify sound zone to provide personalized audio to the user positioned proximate to the personal audio device 150(N). In various embodiments, a subset of loudspeakers 232 within the vehicle may be associated with a predetermined sound zone (e.g., the sound zone 402(1)). In such instances, the wireless audio unit 116 identifies the subset of loudspeakers 232 upon identifying the sound zone 402(1). Alternatively, the wireless audio device 116 uses a selection algorithm to identify a set of loudspeakers 232 in the vehicle 302 that are to provide sound to the sound zone 402(1).

At step 514, the wireless audio unit 116 manages vehicle loudspeakers 232 for the sound zone 402. In various embodiments, the wireless audio unit 116 manages the set of loudspeakers 232(N) that are associated with the sound zone 402(1) identified in step 512. In some embodiments, the wireless audio unit 116 mutes the loudspeakers 232(N) for the sound zone 402(1) such that the personal audio device 150(N) reproduces the audio signal in lieu of the loudspeakers 232(N). Alternatively, the wireless audio unit 116 can manage the loudspeakers 232(N) to reproduce the audio signal in conjunction with the personal audio device 150(N). In such instances, the wireless audio unit 116 provides respectively portions to the personal audio device 150(N) and the loudspeakers 232(N) for reproduction within the sound zone 402(1).

At step 516, the wireless audio unit 116 synchronizes the audio stream to the sound zone 402. In various embodiments, the synchronization module 266 of the wireless audio unit 116 synchronizes the audio stream provided over the wireless communication link 312(N) to the personal audio device 150(N) and/or audio links 332(N) to the loudspeakers 232(N) in the sound zone 402(1) to enable the devices to reproduce the audio signal. In various embodiments, the synchronization module 266 performs various techniques to reduce the latency between the audio source providing the audio signal and the personal audio device 150(N) reproducing the audio signal. For example, the wireless audio unit can dedicate a larger amount of processing resources to increase the throughput over the communications links 312(N), 332(N).

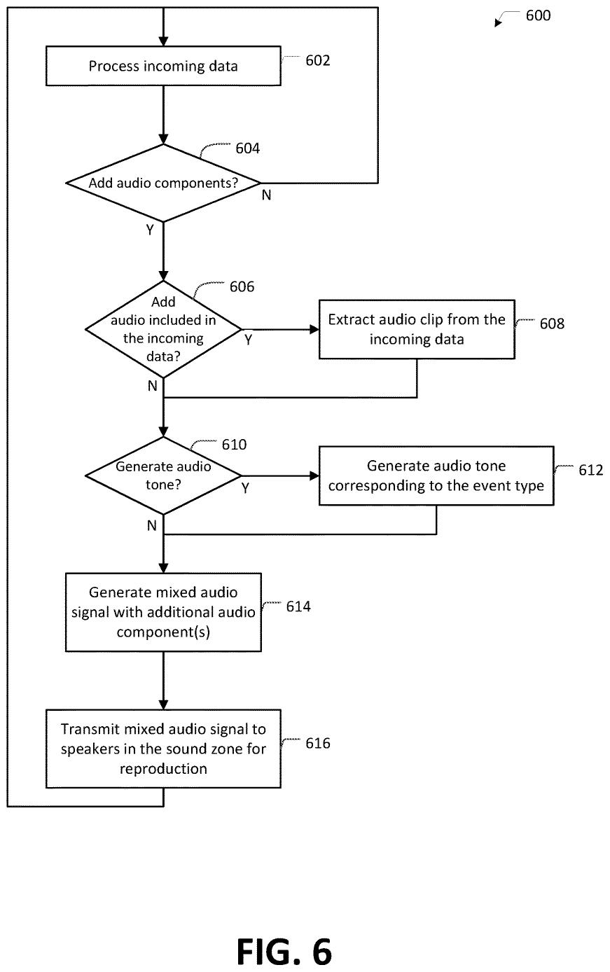

FIG. 6 illustrates a flow diagram of method steps for generating a mixed audio signal based on data from a vehicle environment, according to various embodiments. Although the method steps are described with respect to the systems of FIGS. 1-5, persons skilled in the art will understand that any system configured to perform the method steps, in any order, falls within the scope of the various embodiments.

As shown, the method 600 begins at step 602, where the wireless audio unit processes incoming data. In various embodiments, the input processing module 262 of the wireless audio unit 116 processes data from various devices (e.g., the sensors 130, the remote data sources 170, the entertainment subsystem 222, the network module 224, the navigation subsystem 226, etc.). The incoming data is associated with the environment, such as audio data from microphones recording the exterior environment of the vehicle, utterances from other occupants of the vehicle, events associated with the operation of the entertainment subsystem 222, the network module 224, the navigation subsystem 226, and so forth. In various embodiments, the input processing module 262 processes the incoming data while the output generation module 264 streams the audio signal to personal audio device 150 and the loudspeakers 232(N) for the sound zone 402(1). In such instances, the input processing module 262 can continually process the incoming data while the wireless communication link 312(N) is established with the personal audio device 150(N).

At step 604, the wireless audio unit 116 determines whether to add audio components to the audio signal based on the incoming data. In various embodiments, the input processing module 262 determines whether the incoming data indicates that an additional audio component is to be mixed with the audio signal. For example, the input processing module 262 receives a CAN message from a driver assistance system indicating an alert condition. In such instances, the input processing module 262 determines to provide additional audio components based on the alert condition. When the wireless audio unit 116 determines to add audio components, the wireless audio unit 116 proceeds to step 606; otherwise, the wireless audio unit 116 determines to not to add audio components and returns to step 602 to further process incoming data.

At step 606, the wireless audio unit 116 determines whether to add audio that is included in the incoming data. In various embodiments, the input processing module 262 determines to add audio content that is included in the incoming data. For example, the input processing module 262 responds to the CAN message from the driver assistance system by adding ambient sounds recorded by vehicle sensors 214 of the exterior environment. In another example, the input processing module 262 detects a conversation between two or more vehicle occupants that includes the user. In such instances, the input processing module 262 determines to include the utterances of the vehicle occupants that are recorded by an occupant-facing sensors 216 and/or a compartment microphone 218. When the wireless audio unit 116 determines to add the audio content from the incoming data, the wireless audio unit 116 proceeds to step 608. Otherwise, the wireless audio unit 116 proceeds to step 608.

At step 608, the wireless audio unit 116 extracts the audio clip from the incoming data. In various embodiments, the input processing module 262 identifies the audio clip for inclusion as the additional audio content. In such instances, the input processing module 262 extracts the audio clip from the set of incoming data. In some embodiments, the input processing module 262 further processes the audio clip. For example, when the audio clip is of ambient sounds of the environment, the input processing module 262 filters out portions of the ambient sound, such as by isolating specific sounds in the environment (e.g., emergency sirens, traffic notification sounds, etc.). In some embodiments, the input processing module 262 generates an audio loop from the audio clip such that a longer version of the audio clip is added to the audio signal.

At step 610, the wireless audio unit 116 determines whether to generate an audio tone. In various embodiments, the input processing module 262 determines whether to generate an audio tone to mix with the audio signal. For example, the input processing module 262 can at step 604 detect an event that is associated with an audio tone (e.g., an alert condition, a navigation event, a notification provided by the entertainment subsystem 222, etc.). The audio tone can be generated in addition to audio content (e.g., an alert tone in addition to the ambient sound) or to indicate a non-audio event. When the wireless audio unit 116 determines to generate the audio tone, the wireless audio unit 116 proceeds to step 612; otherwise, the wireless audio unit 116 determines not to add an audio tone and proceeds to step 614.

At step 612, the wireless audio unit 116 generates the audio tone corresponding to the determined event type. In various embodiments, upon determining the type of event that is to be indicated with an audio tone, the wireless audio unit 116 identifies an audio tone corresponding to the event type. In some embodiments, the data store 118 stores a set of tones that correspond to specific event types. For example, the data store 118 can store an air horn tone that is mapped to an alert event type, a bell alert that is mapped to an incoming call event type, a harp-string tone that is mapped to a navigation event type, and/or the like. In such instances, the output generation module 264 of the wireless audio unit 116 generates the audio tone that is mapped to the determined event type.

At step 614, the wireless audio unit 116 generates a mixed audio stream with the additional audio components. In various embodiments, the output generation module 264 of the wireless audio unit 116 mixes the additional audio components (e.g., the audio clip and/or the audio tone) with the audio signal to generate a mixed audio signal. In various embodiments, the mixed audio signal includes an attenuated version of the audio signal provided by the audio source and the additional components. In this manner, the speakers in the sound zone 402 reproduce audio that provides contextual information about the vehicle environment during playback of the audio signal. In some embodiments, the wireless audio unit 116 mixes the signal by substantially attenuating or muting specific ranges of the audio signal. In such instances, the additional audio components are more prominent in the mixed audio signal and are easier for the user to hear during playback.

At step 616, the wireless audio unit 116 transmits the mixed audio signal to the sound zone for reproduction. In various embodiments, the output generation module 264 of the wireless audio unit 116 transmits the mixed audio signal to the personal audio device 150(N) and the loudspeakers 232(N) in the sound zone 402(1) for reproduction. In some embodiments, the output generation module 264 generates separate component signals from the mixed audio signal. In such instances, the wireless audio unit 116 transmits the respective component signals to the devices in the sound zone 402(1) to reproduce a component of the mixed audio signal. Upon transmitting the mixed audio signal for reproduction, the wireless audio unit 116 returns to step 602 to process other incoming data.

In sum, a wireless audio unit manages audio signals provided to one or more personal audio devices for occupants of a vehicle. The wireless audio unit detects a given personal audio device and the position of the personal audio device within the vehicle. The wireless audio unit loads a stored profile for the personal audio device and/or the user associated with the personal audio device. The wireless audio unit establishes a communications link with the personal audio device to provide an audio stream for play back by the personal audio device. In various embodiments, the wireless audio unit determines an audio zone for the personal audio device based on the position of the personal audio device within the vehicle and manages one or more speakers in the sound zone, such as by muting the speakers, or by providing portions of the audio stream to the speakers for reproduction of the audio stream in conjunction with the personal audio device.

Upon streaming an audio signal to the personal audio device, the wireless audio unit processes incoming data received from one or more vehicle components, such as audio data, sensor data, and/or other types of data. The wireless audio unit processes the data to determine whether to add audio portions to the audio stream. When the wireless audio unit determines to add audio portions, the wireless audio unit extracts an audio clip from the incoming data or adds an audio tone notification. The wireless audio unit mixes the additional audio portion with the audio stream to generate a mixed audio stream for transmission to the personal audio device and speakers in the sound zone.

At least one technological advantage of the integrated in-vehicle personal audio system relative to the prior art is that, with the disclosed techniques, the integrated in-vehicle personal audio system provides high-fidelity audio reproductions of audio signals within a vehicle while providing contextual information about a driving environment to occupants of the vehicle. Further, by incorporating compatible personal audio components to generate a personalized sound zone for a given occupant, the integrated in-vehicle personal audio system provides a less-complex, more cost-efficient solution to provide high-fidelity audio to individuals than conventional in-vehicle audio systems. These technical advantages provide one or more technological advancements over prior art approaches.
1. In various embodiments, a computer-implemented method comprises detecting, by a wireless audio unit of a vehicle, one or more personal audio devices within the vehicle, establishing a wireless link with at least a first personal audio device of the one or more personal audio devices, synchronizing communications over the wireless link to the first personal audio device, and transmitting, from the wireless audio unit to the first personal audio device, an audio signal over the wireless link for playback by the first personal audio device.
2. The computer-implemented method of clause 1, further comprising establishing at least a second wireless link with a second personal audio device of the one or more personal audio devices, and transmitting, from the wireless audio unit to the second personal audio device, a second audio signal over the second wireless link for playback, wherein the wireless audio unit transmits the second audio signal while the wireless link is established with the first personal audio device.
3. The computer-implemented method of clause 1 or 2, further comprising receiving, from a vehicle component, a set of incoming data, determining, based on the set of incoming data, an additional component signal to add to the audio signal, mixing the additional component signal with the audio signal to generate a mixed audio signal, and transmitting, from the wireless audio unit to the first personal audio device, the mixed audio signal.
4. The computer-implemented method of any of claim 1-3, further comprising extracting an audio clip from an additional audio signal included in the incoming data, and generating the additional component signal from the audio clip.
5. The computer-implemented method of any of claims 1-4, further comprising determining that the set of incoming data corresponds to an alert, generating an alert tone corresponding to the alert, where the additional component signal includes the alert tone.
6. The computer-implemented method of any of claims 1-5, further comprising ducking the audio signal to generate an attenuated audio signal, where mixing the additional component signal with the audio signal comprises mixing the additional component signal with the attenuated audio signal.
7. The computer-implemented method of any of claims 1-6, further comprising generating a second wireless link with a mobile device, and prior transmitting the audio signal, receiving the audio signal from the mobile device.
8. The computer-implemented method of claims 1-7, further comprising determining a position of the first personal audio device within the vehicle, generating, using a plurality of speakers mounted in the vehicle and the first personal audio device, a sound zone configured to reproduce sound to a single occupant of the vehicle.
9. The computer-implemented method of claims 1-8, further comprising muting the plurality of speakers.
10. The computer-implemented method of claims 1-9, further comprising identifying a set of speaker characteristics for the plurality of speakers and the first personal audio device, generating an output profile based on the set of speaker characteristics, and modifying the audio signal based on the output profile.
11. In various embodiments, one or more non-transitory computer-readable media store instructions that, when executed by one or more processors, cause the one or more processors to perform the steps of detecting, by a wireless audio unit of a vehicle, one or more personal audio devices within the vehicle, establishing a wireless link with at least a first personal audio device of the one or more personal audio devices, synchronizing communications over the wireless link to the first personal audio device, and transmitting, from the wireless audio unit to the first personal audio device, an audio signal over the wireless link for playback by the first personal audio device.
12. The one or more non-transitory computer-readable media of claim 11, where the steps further comprise receiving, from a vehicle component, a set of incoming data, determining, based on the set of incoming data, an additional component signal to add to the audio signal, wherein the additional component signal includes at least one of an audio clip from an additional audio signal included in the incoming data, or an alert tone corresponding to an alert triggered by the set of incoming data, mixing the additional component signal with the audio signal to generate a mixed audio signal, and transmitting, from the wireless audio unit to the first personal audio device, the mixed audio signal over the wireless link for playback.
13. The one or more non-transitory computer-readable media of clause 11 or 12, where the steps further comprise identifying a first user identifier associated with the first personal audio device, identifying, in a data store storing one or more user profiles, a first user profile associated with the first user identifier, modifying the audio signal based on the user profile.
14. The one or more non-transitory computer-readable media any of claims 11-13, where the steps further comprise generating a second wireless link with a mobile device, and prior to transmitting the audio signal, receiving the audio signal from the mobile device.
15. The one or more non-transitory computer-readable media of any of claims 11-14, where the steps further comprise, determining a position of the first personal audio device within the vehicle, identifying, from a plurality of speakers mounted in the vehicle, a sound zone including a set of speakers that is configured to reproduce sound to a single occupant of the vehicle.
16. The one or more non-transitory computer-readable media of any of claims 11-15, where the wireless audio unit is a device integrated into a seat or other portion of the vehicle or a device that is detachable from a mount included in the vehicle.
17. The one or more non-transitory computer-readable media of any of claims 11-16, wherein the wireless audio unit is included in a head unit of the vehicle.
18. In various embodiments, a system comprises a memory storing a wireless audio management application, and a processor coupled to the memory that executes the wireless audio management application by performing the steps of detecting, by a wireless audio unit of a vehicle, one or more personal audio devices within the vehicle, establishing a wireless link with at least a first personal audio device of the one or more personal audio devices, synchronizing communications over the wireless link to the first personal audio device, and transmitting, from the wireless audio unit to the first personal audio device, an audio signal over the wireless link for playback by the first personal audio device.
19. The system of clause 18, where the first personal audio device comprises one of headphones, earbuds, a wearable device, or one or more directional wireless speakers.
20. The system of clause of 18 or 19, where the steps further comprise receiving, from a vehicle component, a set of incoming data, determining, based on the set of incoming data, an additional component signal to add to the audio signal, where the additional component signal includes at least one of an audio clip from an additional audio signal included in the incoming data, or an alert tone corresponding to an alert triggered by the set of incoming data, mixing the additional component signal with the audio signal to generate a mixed audio signal, and transmitting, from the wireless audio unit to the first personal audio device, the mixed audio signal over the wireless link for playback.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method comprising:
detecting, by a wireless audio unit of a vehicle, one or more personal audio devices within the vehicle;
establishing a wireless link with at least a first personal audio device of the one or more personal audio devices;
synchronizing communications over the wireless link to the first personal audio device; and
transmitting, from the wireless audio unit to the first personal audio device, an audio signal over the wireless link for playback by the first personal audio device.

2. The computer-implemented method of claim 1, further comprising:
establishing at least a second wireless link with a second personal audio device of the one or more personal audio devices; and
transmitting, from the wireless audio unit to the second personal audio device, a second audio signal over the second wireless link for playback, wherein the wireless audio unit transmits the second audio signal while the wireless link is established with the first personal audio device.

3. The computer-implemented method of claim 1, further comprising:
receiving, from a vehicle component, a set of incoming data;
determining, based on the set of incoming data, an additional component signal to add to the audio signal;
mixing the additional component signal with the audio signal to generate a mixed audio signal; and
transmitting, from the wireless audio unit to the first personal audio device, the mixed audio signal.

4. The computer-implemented method of claim 3, further comprising:
extracting an audio clip from an additional audio signal included in the incoming data; and
generating the additional component signal from the audio clip.

5. The computer-implemented method of claim 3, further comprising:
determining that the set of incoming data corresponds to an alert;
generating an alert tone corresponding to the alert, wherein the additional component signal includes the alert tone.

6. The computer-implemented method of claim 3, further comprising:
ducking the audio signal to generate an attenuated audio signal,
wherein mixing the additional component signal with the audio signal comprises mixing the additional component signal with the attenuated audio signal.

7. The computer-implemented method of claim 1, further comprising:
generating a second wireless link with a mobile device; and
prior transmitting the audio signal, receiving the audio signal from the mobile device.

8. The computer-implemented method of claim 1, further comprising:
determining a position of the first personal audio device within the vehicle;
generating, using a plurality of speakers mounted in the vehicle and the first personal audio device, a sound zone configured to reproduce sound to a single occupant of the vehicle.

9. The computer-implemented method of claim 8, further comprising muting the plurality of speakers.

10. The computer-implemented method of claim 8, further comprising:
identifying a set of speaker characteristics for the plurality of speakers and the first personal audio device;
generating an output profile based on the set of speaker characteristics; and
modifying the audio signal based on the output profile.

11. One or more non-transitory computer-readable media storing instructions that, when executed by one or more processors, cause the one or more processors to perform the steps of:
detecting, by a wireless audio unit of a vehicle, one or more personal audio devices within the vehicle;
establishing a wireless link with at least a first personal audio device of the one or more personal audio devices;
synchronizing communications over the wireless link to the first personal audio device; and
transmitting, from the wireless audio unit to the first personal audio device, an audio signal over the wireless link for playback by the first personal audio device.

12. The one or more non-transitory computer-readable media of claim 11, wherein the steps further comprise:
receiving, from a vehicle component, a set of incoming data;
determining, based on the set of incoming data, an additional component signal to add to the audio signal, wherein the additional component signal includes at least one of:
an audio clip from an additional audio signal included in the incoming data, or
an alert tone corresponding to an alert triggered by the set of incoming data;
mixing the additional component signal with the audio signal to generate a mixed audio signal; and
transmitting, from the wireless audio unit to the first personal audio device, the mixed audio signal over the wireless link for playback.

13. The one or more non-transitory computer-readable media of claim 11, wherein the steps further comprise:
identifying a first user identifier associated with the first personal audio device;
identifying, in a data store storing one or more user profiles, a first user profile associated with the first user identifier;
modifying the audio signal based on the user profile.

14. The one or more non-transitory computer-readable media of claim 11, wherein the steps further comprise:
generating a second wireless link with a mobile device; and
prior to transmitting the audio signal, receiving the audio signal from the mobile device.

15. The one or more non-transitory computer-readable media of claim 11, wherein the steps further comprise:
determining a position of the first personal audio device within the vehicle;
identifying, from a plurality of speakers mounted in the vehicle, a sound zone including a set of speakers that is configured to reproduce sound to a single occupant of the vehicle.

16. The one or more non-transitory computer-readable media of claim 11, wherein the wireless audio unit is a device integrated into a seat or other portion of the vehicle or a device that is detachable from a mount included in the vehicle.

17. The one or more non-transitory computer-readable media of claim 11, wherein the wireless audio unit is included in a head unit of the vehicle.

18. A system comprising:
a memory storing a wireless audio management application; and
a processor coupled to the memory that executes the wireless audio management application by performing the steps of:
detecting, by a wireless audio unit of a vehicle, one or more personal audio devices within the vehicle;
establishing a wireless link with at least a first personal audio device of the one or more personal audio devices;
synchronizing communications over the wireless link to the first personal audio device; and
transmitting, from the wireless audio unit to the first personal audio device, an audio signal over the wireless link for playback by the first personal audio device.

19. The system of claim 18, wherein the first personal audio device comprises one of headphones, earbuds, a wearable device, or one or more directional wireless speakers.

20. The system of claim 18, wherein the steps further comprise:
receiving, from a vehicle component, a set of incoming data;
determining, based on the set of incoming data, an additional component signal to add to the audio signal, wherein the additional component signal includes at least one of:
an audio clip from an additional audio signal included in the incoming data, or
an alert tone corresponding to an alert triggered by the set of incoming data;
mixing the additional component signal with the audio signal to generate a mixed audio signal; and
transmitting, from the wireless audio unit to the first personal audio device, the mixed audio signal over the wireless link for play back.
